(19) United States
(12) Patent Application Publication
(10) Pub. No.: US 2003/0095253 A1
(43) Pub. Date: May 22, 2003

(54) Container sensor system

(76) Inventor: Raymond Yiu Man Chow, Kowloon (CN)

Correspondence Address: Curt Harrington, Suite 250, 6300 State University Drive, Long Beach, CA, 90815, US

(21) Appl. No.: 09/990,858

(22) Filed: Nov. 21, 2001

(51) Int. Cl. G01N 21/90

(52) U.S. Cl. 356/240.1

(57) ABSTRACT

A variety of improvements in the technology relating to containers and more particularly to the use of a mechanism in conjunction with a bottle, to determine if it has been opened are illustrated.

### FIELD OF THE INVENTION

The present invention relates to improvements in the technology relating to containers and more particularly to the use of a mechanism in conjunction with a bottle, to determine if it has been opened and optionally thereafter once opening is detected to trigger some other type of action or signal, and especially a system which can be used by manufacturers, distributors, and home users.

### BACKGROUND OF THE INVENTION

A closed container, especially a bottle is a system of high interest with regard to detecting a breach of integrity. The object for detecting a breach of the sealed container is to notify the user that the contents may have been compromised or removed, to warn others of the breach, or simply as a delightful novelty to mark the unsealing of the closed container.

The bottle as a secure container is of particular interest because the physical breach occurs at only a small area enclosing the total volume. Of even further interest is the ability to detect a breach of the bottle seal as soon as it is breached. Other considerations flow from the wide variety of materials which are employed for the bottle structure, the wide variety of materials which the bottle may contain, and an even wider variety of shapes and materials used to close the bottle.

The bottle may be made of metal, glass, ceramic, plastic, wood, cardboard and more. The utilization of sensors may work well with some materials and not others. In other cases, some materials may simply have to be avoided to work with the particular mechanism employed.

The material contained is a further factor which may be used to advantage in detecting containment breach, or it may complicate some of the mechanisms utilized to detect containment breach. Further, the object of using a particular material in combination with a contained substance may cause further complications.

Bottle structure, especially in combination with closure structure is another major consideration. Some bottles have threaded metal caps, others have friction stoppers made of cork or polymeric materials. Detecting container breach by detecting physical effects from and physical movement of the cap or stopper is yet another physical aspect to be measured. Another method of determining breach might be measured from a detection of the physical methods available to open the bottle.

What is needed are new ways to detect container breach by measuring at least one of characteristic of the container, opening cap or plug, or material contained within the container.

### SUMMARY OF THE INVENTION

Improvements in the technology relating to containers and more particularly to the use of a mechanism in conjunction with a bottle, to determine if it has been opened and optionally thereafter once opening is detected are illustrated, and include electrical, optional and motion sensing.

### BRIEF DESCRIPTION OF THE DRAWINGS

The invention, its configuration, construction, and operation will be best further described in the following detailed description, taken in conjunction with the accompanying drawings in which:

FIG. 1 is a side sectional view of a bottle illustrating details of a bottom cavity and controlled window for providing a known light portal to a reflective structure mounted underneath a stopper member;

FIG. 2 is a side sectional view of a bottle illustrating details of a bottom cavity with metalization and an adjacent silica cup with metalization mounted adjacently to form a pressure variable capacitor and where the changes in capacitance indicate an opening of the bottle;

FIG. 3 illustrates a bottle having a defined region with reflective metalization for affecting the light path of a light transmitter with respect to a receiver to determine pressure differences in the bottle;

FIG. 4 illustrates a bee hive shaped length of fiber optic rigidly fixed to the bottom of a bottle to determine pressure changes within the bottle;

FIG. 5 is a segmented stopper member with one portion of the stopper member including an electronic housing 143 with the other and bulk volume of the stopper member having a mass of sealing cork or elastomer to accommodate a metallic corkscrew to affect a relationship between a magnet and reed switch;

FIG. 6 illustrates a side view of the stopper member of FIG. 5;

FIG. 7 illustrates a variation on the stopper of FIGS. 5 and 6 utilizing thin plates of foil which take up the predominant cross sectional area within the bulk of the mass of the sealing volume such that introduction of a cork screw will trigger conductivity between the layers and trigger circuitry within the electronics section;

FIG. 8 illustrates an external conductivity structure which is utilized by a cap or stopper having an overhang such that a ring will be removed when the cap or stopper is removed;

FIG. 9 illustrates a top view of one possible configuration of an integral housing utilizable with the external conductivity structure of FIG. 8;

FIG. 10 illustrates the components of the system of FIGS. 8 and 9 employed onto a bottle having a stopper with an overlying flange;

FIG. 11 illustrates the components of the system of FIGS. 8 and 9 but without a central aperture as used on a bottle with rounded stopper and where the center of the ring covers the upper area of the stopper;

FIG. 12 illustrates a collar detection system utilized with threaded magnets which can be employed on bottles in a custom environment, or onto bottles which have already been filled and sealed, or upon bottles by a user to enable custom installations, and including a collar detector;

FIG. 13 illustrates the system of FIG. 12, but modified to accommodate a metal cap and integral seal to provide a center magnet to operate with a collar detector;

FIG. 14 illustrates a collar detector which is a separable collar forming two halves and which can be fitted by the user around the neck of a bottle;

FIG. 15 illustrates a partial collar housing utilizable with a plastic zip tie; and

FIG. 16 is an illustration of a side sectional view of a bottle utilizing a radio frequency identification system, RFID, with the bulk of the electronics in its base and with examples of both active and passive transducers in a cork; and,

FIG. 17 is an illustration of a side sectional view of a bottle utilizing a radio frequency identification system, RFID, with the bulk of the electronics in its stopper member and with examples of an active and passive transducer in a base housing.

### DETAILED DESCRIPTION OF THE PREFERRED EMBODIMENT

The description and operation of the invention will be best initiated with reference to FIG. 1 and which illustrates a side sectional view of a bottle 21. Bottle 21 has an overall shape of a wine bottle having a bottom exterior concave or flat surface 23, underneath what appears from a side view to be an arch, but which is a somewhat curved or flat cup shaped bottom wall 25. Bottle 21 also has a generally cylindrically shaped exterior surface 27 on a cylindrical side wall 29, and an upper shoulder surface 31 on an upper shoulder wall 33. Shoulder wall 33 leads to and may be continuous with a neck 35 which may or may not have a reinforcement radial member 37. Above bottle 21 is seen a stopper member 41 which may be made of a variety of materials. Stopper member 41 fits into an opening 43 of the neck 35. Below the neck 35 on the interior of the bottle 21, a liquid mass 45 is seen.

The cup or flat shaped bottom wall 25 contains a defined region 51 which has a controlled physical characteristic. The controlled physical characteristic includes at least one of size, shape, and thickness. Further, the material of defined region 51 can also be varied, and especially where bottle 21 is made wholly of glass, since silica fuses so readily. The cup shaped bottom wall 25 is of a typical looking shape which is seen for so many wine bottles, but its size and specific shape can be exactly controlled through the molding process. Further, the introduction of a ram through the opening 43, during the production of the bottle 21 will allow the defined region 51 to be exactly controlled in terms of its area and thickness. Where a clear piece of silica is to be introduced, the ram can also hold a pre-formed silica window against a bottom of the mold in which the bottle 21 is made, for example, in place while the remainder of the bottle 21 is introduced into the mold. All of these techniques can be utilized to control the defined region 51 to any needed dimension. The defined region 51 is preferably normal to a center axis 53 of the bottle 21.

Also shown, below the bottom wall 25, is an integral housing 55. A high degree of interfit is shown, although this is not necessary. The integral housing 55 is shown as being an “add on” in length to the bottle 21 in order to show that ports, such as port 57 can be open to the side to allow the transmission of sounds and the like while the bottle 21 is in the upright position, which may be advantageous if the bottle 21 is opened while it is in the upright position. Integral housing 55 is also seen as having an upper central opening 59 to lessen the obstruction between the components inside the integral housing 55 and the access to a bottom surface 61 of the defined region 51 of the bottle 21.

In this first embodiment, a light is transmitted from the integral housing 55, through the defined region 51 and towards the cork or stopper member 41. At the bottom of the stopper member 41, a reflective structure 65 is affixed. Reflective structure 65 is shown mounted to the outside bottom of stopper member 41 as it is an option, but largely shown in FIG. 1 as it is a plan view and so that it can be seen. The mounting of a reflective structure 65 on the stopper member 41 enables a return of light directed in the direction of the stopper. Further, the shape of the reflective structure 65 can range from concave for focussing light, to flat for an even light return, to convex to cause a spreading of the returned light. Because the stopper member 41 is typically an item of mass production, the placement and orientation of any reflective structure 65 is expected to be highly precise. Further, the reflective structure 65 can be recessed back into a bore to further protect it. Where it is a thin foil, it will allow a corkscrew to pass easily through it without dropping into the material in the bottle.

As by example, the integral housing 55 is seen as containing a light transmitter 71 and a light detector 73. In the drawing of FIG. 1, the light transmitter 71 is located just to one side of the center axis 53 while the light detector 73 is located generally an equivalent distance just away from the other side of the center axis 53. The light is shown as traveling from the transmitter 71 and reflecting from where the reflective structure 65 would be if the stopper member 41 were in place. The exterior interfitting portions of the integral housing 55 are expected to fit very well with the exterior bottom of the bottle 21. Transmitted light from the transmitter 71 is controlled by a circuit board 75. Circuit board 75 may also preferably carry its own power supply or external power in the form of inexpensive batteries. When the circuits of the circuit board 75, by virtue of their connection with the detector 73, no longer indicate receipt of a reflected signal from the reflective structure 65, an instant indication that the stopper member 41 is being dislodged is obtained. At this point, the circuit of the circuit board 75 causes a speaker 77, or other component, to be actuated with a signal which may be one of a siren, music, instructions and the like, including instructions to be heard on opening, instructions to be heard on closing, or both. Opening instructions may relate to use or give hazardous material codes or simply a congratulatory message. Closing instructions may relate to details of storage, a record of the number of times the bottle 21 has been opened, or other information. In some cases new instructions may be recordable, in the event that conditions may have changed. An optional motion detector 79 is preferably and optionally utilized to conserve power of, and reduce the transmissions from the transmitter 71 during the relatively long periods in which the combination bottle 21 and integral housing 55 is in static storage. This storage time may amount to 99% of the time between the bottling of the liquid mass 45 and the eventual opening of the bottle 21. The use of a motion detector 79 in conjunction with a timer insures that detection will be occurring at the time of opening.

As to further detail of the arrangement, the transmitter 71 should emit a light which is not absorbed by the liquid mass 45. For example, a red wine typically absorbs all wavelengths of light but red, and thus a transmitter 71 transmitting red light through a red wine may have the requisite transmissibility. Also, greater reliability, all other factors being equal, is had where the defined region 51 is closer to the reflective structure 65. Defined region 51 can be brought higher and the integral housing 55 can be made similarly shaped. The exterior surface and interior surface of the defined region 51 should be as optically flat as possible. Further, where the wavelength of light to be transmitted by the transmitter 71 is known, the thickness of defined region 51 may be controlled to be an exact number of half wavelengths in order to minimize reflectivity loss.

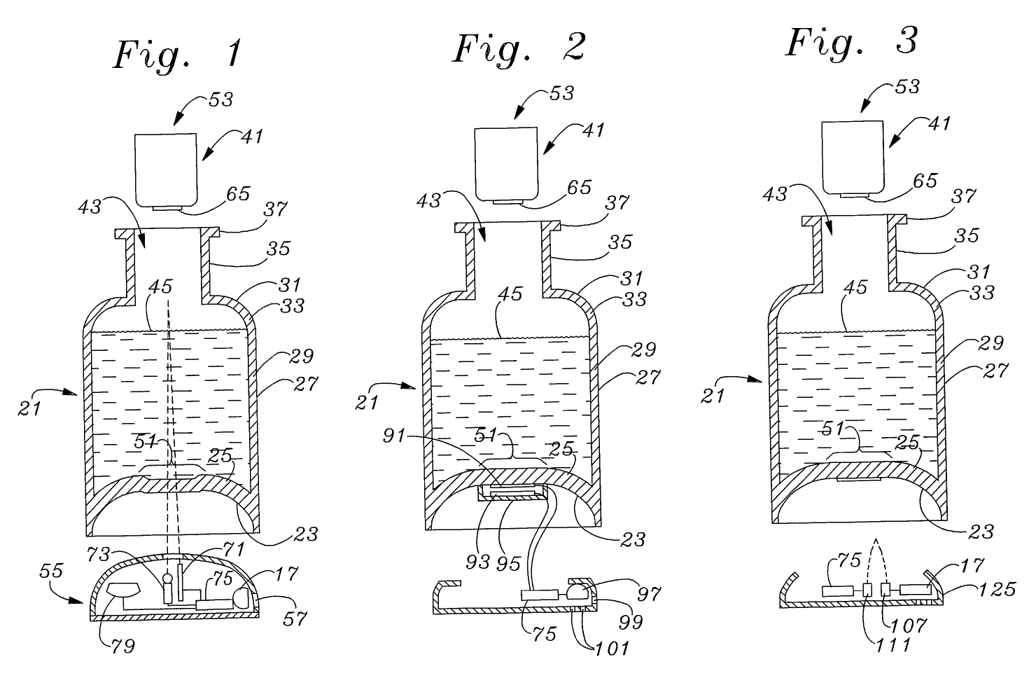

Referring to FIG. 2, another advantage which can be taken of a defined region 51 includes its reaction to pressure. A small layer of metalization 91 may be applied to the bottom surface or exterior surface of the defined region 51, with a conductive trace connected to circuit board 75. A second metalization layer 93 is applied to a silica “cup” 95 which is fused to the bottom of the bottom exterior concave or flat surface 23, often simply by touching the two surfaces together. The space between the first and second metalization layers 91 and 93 form a capacitor which may be charged by the circuit supported by the circuit board to thereby measure the capacitance. At the time the liquid mass 45 is added, and before the stopper member 41 is fitted in place, a positive or negative pressure is added to the space above the liquid mass 45 to create a positive or negative pressure acting against the inside surface of the defined region 51, to slightly displace the defined region 51 with respect to the silica cup. Displacement of the defined region 51 moves the metalization layer 91 either closer to or farther away from the metalization layer 93. As such, displacement of the defined region 51 changes the capacitance between the first and second metalization layers 91 and 93, and such change in capacitance is detected by the circuit of circuit board 75, and sounds are transmitted to a speaker 97. The circuit board 75 and speaker 97 are both mounted in a low height integral housing 99. The speaker 97 transmits through apertures 101 in the bottom of the integral housing 99. The pressure differential applied to the liquid mass 45 should have a magnitude that will not register a significant change except upon the occurrence of the removal of the stopper member 41. The circuit of the circuit board 75 may also be programmed to only react to a sudden change in capacitance or pressure increase or drop, as this will eliminate the detection of a change in capacitance due to altitude changes. The defined region, for both the embodiment of FIGS. 1 and 2 can occur anywhere on the bottle 21 and need not be restricted to the bottom portion of bottle 21.

Referring to FIG. 3, a further variation utilizes a low height integral housing 105 which is so low that it fits up into the bottom exterior concave or flat surface 23 with enough room to spare that the bottom of the integral housing 105 will be suspended above any surface on which the bottle 21 is placed. A light transmitter 107 directs a light beam to a reflective metalization layer 109 applied to the exterior surface of the defined region 51. Light reflecting from the reflective metalization layer 109 is detected by a detector 111. Both the transmitter 107 and detector are connected to a circuit board 75. A change in pressure within the bottle 21 will cause the defined region 51 to be deflected upwardly or downwardly and change both the light path length as well as the angle of reflection, depending upon where the transmitter 107 and detector 111 is placed. The expected change in shape of the metalization layer 109 can thus be used to significant advantage to detect pressure changes in the bottle 21.

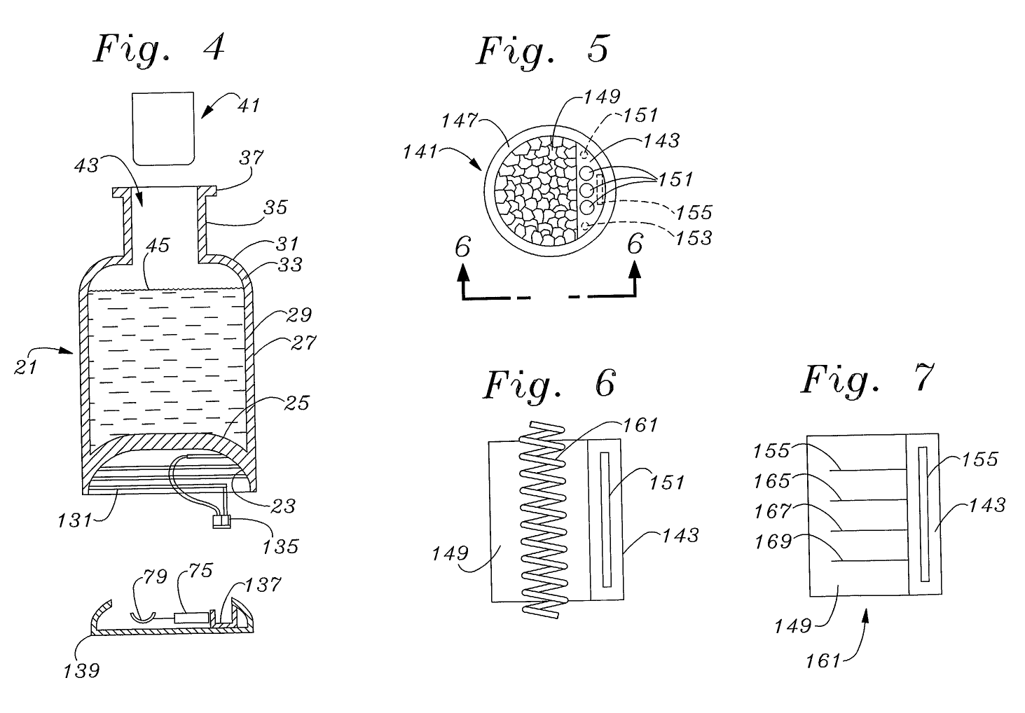

Referring to FIG. 4, bottom exterior concave or flat surface 23 has a beehive shaped spiral of fiber optic cable 131 securely glued to it. The fiber optic cable 131 may be generally pre-formed, but is more effective when very securely attached. The fiber optic cable 131 is two ended, with one end at the outer portion of the spiral and the other end at the center of the spiral, although other orientations are acceptable. The two ends are physically joined in a connector 135. Connector 135 is connected into a connector 137 having an integrated light source and detector, and located in an abbreviated height integral housing 139. The connector 137 is connected to circuit board 75. When the pressure inside the bottle changes, the “optical length” between the ends of the fiber optic cable 131 change due to stress. The electronics which work in conjunction with the fiber optic cable 131 may utilize time domain reflectrometry such that a measurement need only be made every second or so. As shown in FIG. 1, a motion detector 79 may be used to extend the life of the power source of the circuit board 75.

In a variation away from placing the detection electronics at the base of the bottle 21, and referring to FIG. 5, a top view of a stopper member 141 includes an electronics housing 143 having a series of sound apertures 145. The stopper member 141 may have an elastomeric exterior 147 and a cork section 149 where it is desired to provide removal by corkscrew and the like. In reality, the cork section 149 and the curving circumferential extent of the electronics housing 143 may be circularly coated to cause them to present a complete sealing cylindrical surface to present to the inside surface of the neck 35.

As can be seen, the electronics housing 143 is made of a hard material, whereas the cork section 149, and which may be a polymeric section 149, presents an immediate soft invitation for a cork screw. Corkscrews are metallic and the introduction of the corkscrew into the section 149 is an event that may be measured either conductively or magnetically. Shown at one corner of the electronics housing 143 is a magnet 151 shown in phantom. At the other corner of the electronics housing 143 is a reed switch 153 which is under the influence of the magnet 151 to remain in an open position. Electronics section 155 is also shown in dashed line format off to one side.

Referring to FIG. 6, a side view taken along line 6-6 of FIG. 5, but with any elastomeric exterior 147, which could be extremely thin in any event, illustrates the magnet 151. A corkscrew 161 shown penetrating the section 149 provides an attraction for the lines of magnetic flux which would normally extend from the magnet 151 to the reed switch 153. Ideally the reed switch 153 would close to initiate a starting sequence which might involve a further internal relay and the beginning of a sequence broadcast through the sound apertures 145. The circuitry could be set to go through a pre-set time sequence and then shut off, or it could be re-activated by re-insertion of the corkscrew 161, or simply by placing a large piece of metal near the stopper member 141. In this case, the bottles 21 might work better having a larger cylindrical diameter to thus increase the packed interspacing of adjacent necks 35 to thereby reduce the effect of the adjacent magnets. Further, the complete assembly of the stopper member 141 can be tested with a metal rod held nearby to cause the reed switch 153 to close.

Another variation on this embodiment is seen in FIG. 7. FIG. 7 is taken from the same general view as FIG. 6, but at more of a center cut through the electronics housing 143. Rather than cork, the section 149 of FIG. 7 is made of a liquefiable elastomeric substance. The electronics housing 143 is formed with its circuit board 155 connected to at least two medium thin foil conductors, four of which are shown as 163, 165, 167, and 169. Where four foil conductors 163, 165, 167, and 169 are used, foil conductors 163, and 167 may be of the same polarity while 165 and 169 may be of the opposite polarity. Where a conductive cork screw 161 is used, as the screw penetrates the elastomeric section 149, the foil conductors 163, 165, 167, and 169 will be shorted together. Such shorting can trip a relay to cause the circuit board 155 to take action, to issue a warning, or to play a song or make a greeting.

Thus far we have seen isolated sensing and action taken from both ends of a bottle 21. The techniques and components shown can be combined to provide further sensing and communication.

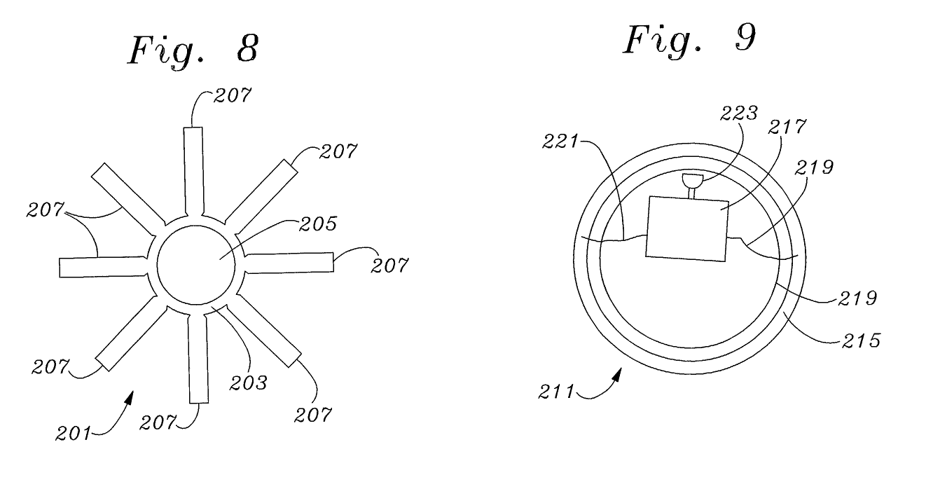

A direct sensing method is seen beginning with FIG. 8. A star shaped single piece of foil 201 has a ring 203 having an optional central aperture 205 which forms an annular ring 203 only when such central aperture is present. The center aperture 205 is for uses in which the ring 203 will generally be expected to lie flat and to adhere to some other member to be removed such as seal or stopper member surface. Also from the ring 203, a plurality and perhaps multiplicity of foil radials 207 extend away from the ring 203. The length of the radials 207 will depend upon the height and contour of the bottle 21, and the foil radials 207 will preferably have decorative colors. The star shaped single piece of foil 201 has a first side and a second side. An adhesive may be applied to both sides of only some of the structures, for example, to one side of each of the radials and to the other side of the ring 203. In this manner, the star shaped single piece of foil 201 can be placed over a bottle 21 such that the radials stick to the sides of the bottle and perhaps a portion of the underside. The ring 203 may have adhesive on the other side, directed upwardly away from the opening 43 is set to stick to any overhang on a stopper as it is brought into place, or the foil radials 207 may be captured within other structures, such as a label overlying the radials 207. Removal of the stopper will tear away the ring 203 and break the conductance between any two or more of the radials 207.

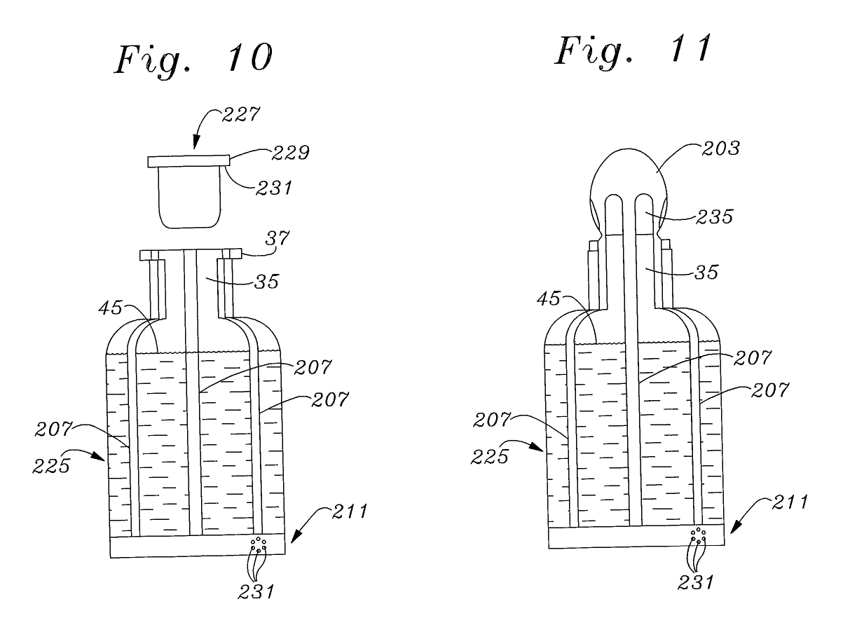

Referring to FIG. 9, an integral housing 211 has an inner section 213 which may be raised or lowered to interfit with the base of bottle 21 or of any bottle, and a ledge 215 to form a further interfit. A circuit board 217 may have conductors 219, 221 leading to the junction between the ledge 215 and inner section 213 to make contact with the radials 207 seen in FIG. 8. Further, the position of the conductors 219 and 221, while calculated to make certain that good contact with the radials is had, need not tell which of the radials 207 with which contact will be made and thus helps to prevent circumvention of the bottle opening detection mechanism. Further, the star shaped single piece of foil 201 can be adhered to a plastic wrapper or other overwrap for application onto a bottle. Circuit board 217 is connected to a speaker 223.

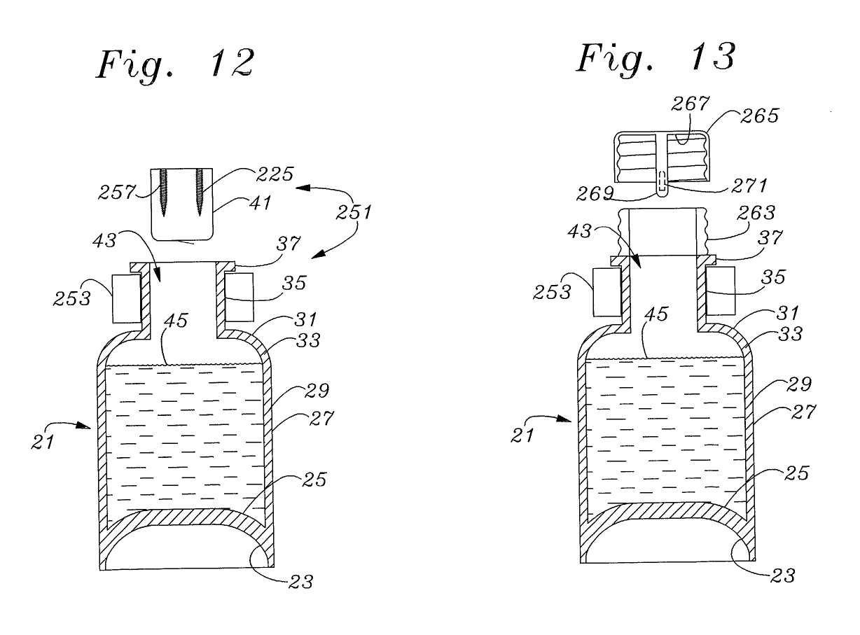

Referring to FIG. 10, a bottle is shown interfitting with and sitting above the integral housing 211. By use of the term “integral housing” throughout the description of all the Figures, it is generally meant that any bottom section have an appearance generally co-extensive with the extent of the bottle or container on which it is attached. As is seen in FIG. 10, the integral housing 211 almost looks as if it is part of the bottom of the bottle 225. Bottle 225 has a stopper 227 which has an overlying flange 229 having an underside 231 which will rest atop the reinforcement radial member 37. The ring 203 will rest above the reinforcement radial member 37 preferably with its adhesive side facing upwardly to engage and attach to the underside 231. When the stopper 27 is removed, it will take the ring 203 with it and break the interconnection of the radials 207, and this will be detected by the circuit board 217 within the integral housing 211. A set of speaker apertures 233 are seen in the integral housing 211.

In another configuration, the aperture 205 is missing from the ring 203 where the ring 203 is meant to overlie another structure entirely. The omission of the aperture 205 prevents the removal of a relatively small stopper member from through the aperture. Further, adhesive applied to the material which would otherwise be removed to form aperture 205 makes it even more certain that the electrical connection with the radials would also be broken. Referring to FIG. 11, a stopper member 235 is covered the material of the ring 203 and adheres to the stopper member 235 firmly. The only way to open is to remove the stopper member 235 and break all of the electrical connections in all of the radials 207.

Where a cork or other polymeric stopper is to fit down inside the neck 35, as was the configuration shown in FIG. 1, the ring 203 can simply be made smaller and either covering the top of the stopper or cork 41 or suspended over it. It is preferable that it cover and adhere by adhesive so that the bulk of the conductive stopper will be taken away and removed with the cork or stopper.

Referring to FIG. 12, a neck detection system 251 is illustrated which can be utilized as an original attachment or retrofit. A collar 253 fits around neck 35 of bottle 21. A stopper member 41, just as before may be provided which typically fits down within opening 43. A pair of very thin magnets are shown as magnets 255 and 257. These magnets 255 and 257 are screw shaped and have pointed ends to orient them with respect to their polarity as they are made to enter the stopper member 41. Only one of the magnets 255 and 257 need be used generally if (1) the geometry of the neck 35 is such that it cannot substantially be placed away from its sensor or (2) the collar 253 cannot move such that the one of the magnets 255 and 257 cannot be substantially displaced away from its sensor (3) if the neck is so thin that the stopper member 41 has been removed. The use of the very small magnets 255 and 257, especially mounted nearest the outer wall of the stopper member 41 serves to permit a free insertion of a cork screw without significant interference. Moreover, the use of threaded magnets 255 and 257 as shown permits placement by home users, original equipment container and material manufacturers (such as wineries), but even more so, retrofit manufacturers. Retrofit manufacturers may purchase a warehouse of sealed bottles and have machinery add the magnetic screws (which can be quite small) as well as the collars 253. The collars can have selector switches to set the sound being emitted. Even more importantly, a user can buy the collar 253 with accompanying magnet as a kit, buy a bottle of wine and insert the magnetic screw into the cork stopper member 41 and then attach the collar. At that point the formed assembly can now be given as a gift.

The sounds emitted by the collar 253 on opening can include (1) music, (2) rude noises, or (3) a pre-recorded message from the giver such as wishing congratulations as well as apologies for not being there to present it personally. Or where the substance in the bottle is dangerous or requires special handling, the collar 253 may emit a warning message. The collar 253 may have two, three or four or several reed switches, especially where the neck 35 has a large diameter or where the collar 253 may be turned.

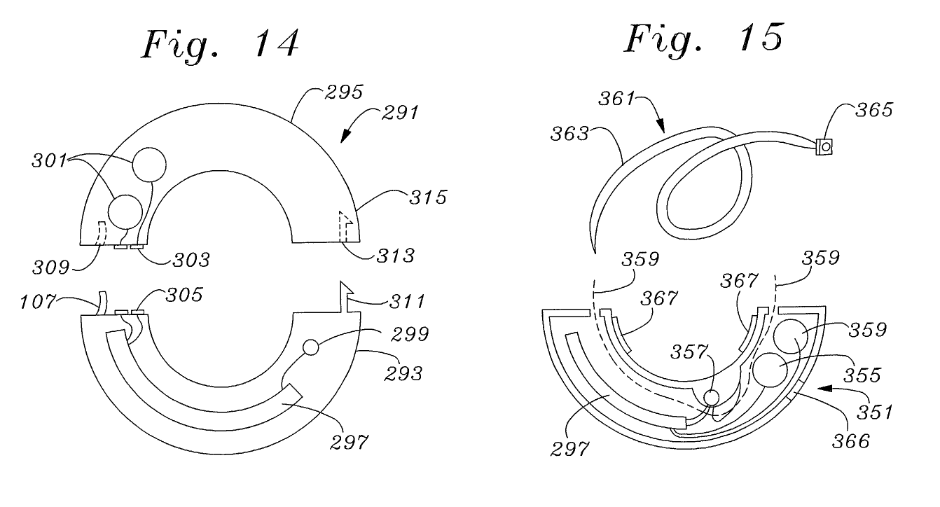

In another slight variation, for example, a manufacturer having a threaded cap may order caps having a magnet member suspended from the cap, and especially the seal member of the cap, and a collar 253 with instructions set to offer warnings. Referring to FIG. 13, a bottle 261 has a radial member 37 underneath a threaded section 263. A metal cap 265 is also threaded and is fitted with an internal plastic seal 267 having a hanging member 269 containing a magnet 271. The magnet, encased by the seal, hangs down to keep a reed switch closed whenever the cap 265 is secured onto the bottle 261.

Two possible configurations will be shown for the collar 253. Referring to FIG. 14, a full, two part collar 291, including half housing members 293 and 295 is illustrated in top view looking down on the collar 291. A circuit board 297 includes either analog or digital chips. A reed switch 299 is connected to the circuit board. A power source such as a batteries 301 may reside in the housing member 293 or 295, here shown withing housing member 293 and having contacts 303 for making contact with contacts 305 in the housing member 293. In the alternative, housing members 293 and 295 may be hinged. A hook 307 engages an aperture 309 to partially enable the members 293 and 295 to be somewhat hinged together. A barb clasp 311 fits through an aperture 313 to form a tight snap lock. An aperture 315 is provided in order that a pin be inserted to unlock the barb clasp 311 and to make somewhat surreptitious the method for putting on and taking off the collar.

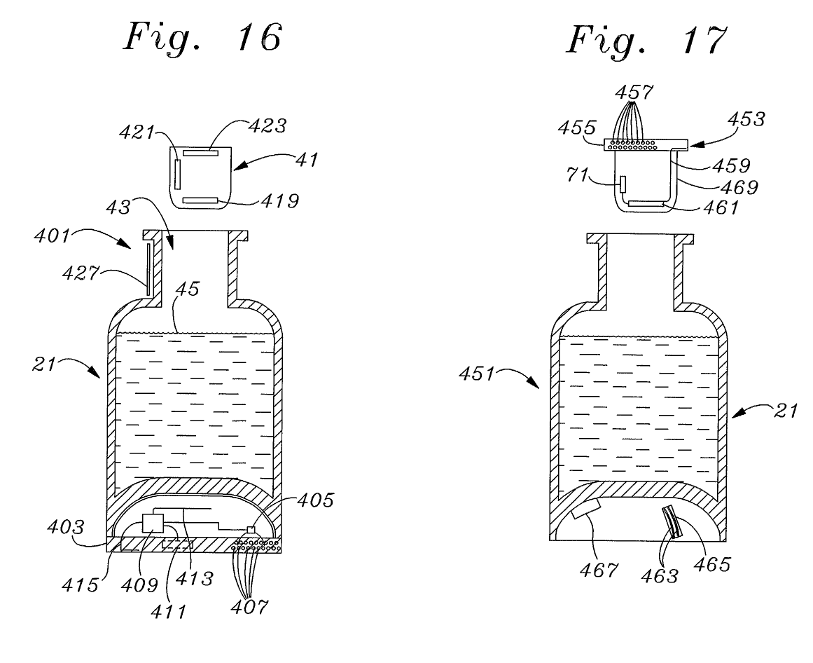

Referring to FIG. 15 a partial collar housing 351 includes a circuit board 353, and a power storage device 355 which can be batteries, or capacitors powered by a solar cell 366, and a special housing mount for the reed switch 357. An internal channel 359 within the partial collar provides a guide path for a locking tie 361. Locking tie 361 is commonly commercially available and provides a length of plastic 363 with a ratchet surface for passing through a locking housing 365. In this configuration, the magnet 255 (seen in FIG. 12) can be added to a stopper member, or a cap 265 (seen in FIG. 13) can be used where the user has the ability to add the partial collar housing 351 to any bottle having any restriction at the top of its neck 35. The ability to pull the tie 361 very tightly also facilitates the use of friction material 367 to make certain that the partial collar 351 stays in place.

Referring to FIG. 16 an illustration of a radio frequency identification system 401 illustrates bottle 21, as before, but having an in-place housing 403 attached to the bottom of the bottle 21, and illustrating a speaker 405 oriented to transmit audible sounds through a series of external apertures 407. Controlled transceiver 409 is connected to a battery 411 which may be replaceable through the bottom of the housing 403. The Controlled transceiver 409 is connected to an antenna 413 which may involve a cone, wire, set of wires, log periodic, or the like, and which may be mounted against the bottom of the bottle 21, or like antenna 415 mounted against or supported by the housing 403.

Since the advent of higher frequency digital control, the antenna has become more critical than the electronics in terms of directionality, frequency spread, and the like. Therefore, in systems where the magnitude of the outgoing signal and its return component are important, it is also important that the position of the other Controlled transceiver is located where the signal is easily detected. Other factors may influence the effectiveness, including the contents of any of the containers shown.

The stopper member 41 may have an active (powered by batteries) or passive Controlled transceiver 419 located at the bottom of the stopper member 41, or it may have an active or passive Controlled transceiver 421 acting at the side of the stopper member 41, or it may have an active or passive Controlled transceiver 423 adjacent the top of the stopper member 41. All three locations provide advantageous variations for interacting with the bottle 21, as well as any opening device.

In general, from one of the antennas 415 or 413 a pulse of energy of a pre-selected frequency is directed at one of the active or passive Controlled transceivers 419, 421 or 423. All of the following relates to either one of the active or passive Controlled transceivers 419, 421 or 423, but Controlled transceiver 419 will be discussed. Typically, where Controlled transceiver 419 is passive, it will be configured to, in real time, receive an electromagnetic signal, and convert that signal to another signal, either by analog or digital means.

For example, where an analog pulse is received, the energy input can be stored momentarily or transferred in a coil or capacitor while a microprocessor checks the intelligence impressed on the incoming signal. At the moment that the intelligence is verified as being of a type to either affirmatively give a reaction or to enable a reaction to be given, an internal microprocessor switch is opened and the energy stored from the Controlled transceiver 419 can be output back to the Controlled transceiver 409.

The action just described need not be performed in a series of steps. Where a series of gates are pre-set to act upon receipt of a code, the action described is instantaneous. Further, because energy gathering can be had regardless of the signal sent from the Controlled transceiver 409, the Controlled transceiver 419 can be configured to store energy from other electromagnetic signals. Thus, when the system 401 is stored in cases and crates, each Controlled transceiver 409, to the extent that the antennas 413 and 415 permit, are bathing the adjacent located systems 401 in usable energy, each system 401 of which stores such energy within Controlled transceiver 419.

In the configuration show for Controlled transceiver 419, the Controlled transceiver 409 can send a coded signal, while the stopper member 41 is in place, and have the stopper member 41 receive the signal and send a return or “handshake” signal to indicate that it is in place. Detection of the removal of the stopper member 41 can be accomplished by a number of methods.

Where the antenna 413 is aligned with an antenna inside the Controlled transceiver 419, removal of the stopper member 41 will cause a dis-alignment of the antenna and the signal strength may fail to such an extent that the Controlled transceiver 409 either detects no coded message being returned to it, or is able to detect a diminution in the strength of the signal associated with the code. In either instance, if disturbance is detected, and a microprocessor within the controlled transceiver 409 connected to the speaker 405 is activated and a message or song or alarm is audibly played.

Where loss of signal is to trigger an action, it can be seen that the actual form for the transceiver 419 can be analog and can be affected by removal of the stopper member 41. For example, depending upon the frequency used, the transceiver 409 could send out and receive back its own coded signal. The transceiving structure need not be limited to a packaged electronic version, but may consist of a storage and re-transmit or reflective antenna which becomes disturbed or interrupted when the stopper member 41 is removed. By detecting its own code as a pre-requisite to refraining from activation, the presence or absence of other signals will not interfere with operation. Also, as is typical for coded systems, they have a duty cycle less than 100% and the interference from other systems 401 should be minimal. Further, the coded signal can be broken up so that, for example, a six digit code is sent one digit at a time over a longer period of time, essentially with down times occurring between the digits.

In terms of a passive electromagnetically reflective structure, an optical solution has been shown which operates in the same manner. A passive electromagnetically reflective structure can be in the form of a reflective transmission line, a combination transmission line and capacitor or the like. The structure can be inside a unit seen as transceiver 419 or it can have an extended reach across the area of the upper portion of the bottle 21.

One method which can be used to produce an electrical change is the breaking of a conductor. For example, the stopper member 41 can be made with conductor which connects a pair of spaced apart transmission lines. With a foil covering for the stopper member 41 providing a connection such that the spaced apart transmission lines operate as an electromagnetic reflector, a breaking of the connection, as by removal of the foil would shift the operation frequency, often the resonant frequency to a frequency at variance with the frequency output by the transceiver 409.

This configuration could be used in reverse, to indicate tampering or opening upon the enablement of the structure to achieve a frequency range matching the transceiver 409. Another physical aspect which can be used to change the electrical characteristics of the transceiver 419 is pressure. Typically the transceiver 419 is elastomeric or cork and has to be compressed to enter the opening 43. A pressure switch within the transceiver 419 could be used to make or break a connection which affects the electrical characteristics of the electromagnetically reflective structure. Other aspects could include pressure for pressure within the bottle 21, changing to an atmospheric pressure. Further, the structure shown previously in FIG. 8 could be configured to act as a reflecting structure while in place on the bottle, and positioned such that the opening of the bottle would cause its destruction.

Other physical aspects may include, with the placement of transceiver 421 a metalization 427 which may act with transceiver 421 to form a composite structure having the proper frequency with which to return the coded signal to the control transceiver 409. For example, metalization layer 427 could form a capacitor with a metalization layer on the side of the stopper member 41, and utilizing the glass material of the bottle 21 in between.

The control transceiver 423 at the top of the stopper member 21 could be used in conjunction with foil or other packaging material to give an indication of opening. Due consideration should be given to the triggering mechanism for the control transceiver 419, 421 and 423 if it is desired to shut the alarm or sounds off upon replacement of the stopper member 41. Any method which results in destruction of an element of one the control transceivers 419, 421 and 423 will create an inability to re-establish detection of a closed condition where the stopper member 41 is replaced in the opening 43.

Other variations on the replacement of the stopper member 41 may include providing controls to enable shutting off and then on the alarm or audible signal, as well as the ability to re-set the system 401 onto another bottle 21.

Another possibility is to combine the digital system of system 401 with any or all of the other methods to indicate a removal or unsealing of the stopper member 41. Where direct conduction is not used, the digital identifier is used to provide the one to one correspondence between the control transceiver 419, 421 and 423 and the housing 403 mounted control transceiver 409.

In another configuration, the control transceiver 419, 421 and 423 can be constructed with internal or external sensors to determine removal of the stopper member 41. In this configuration, the control transceiver 409 can remain largely in sleep mode to conserve battery 411 power. When the stopper member 41 is removed, one of the control transceivers 419, 421 and 423, as may be positioned to best sense removal, then transmits a signal to the control transceiver 409 to signal the alarm condition. In this configuration, the condition may be reproducible to allow the stopper member 41 to be replaced and indicate by sending a signal that the stopper member 41 has been replaced. This type of configuration could ideally utilize two codes, one for indicating removal of the stopper member 41 and one for indicating replacement of the stopper member 41.

Several sub versions of this configuration involve triggering protocols, including a more complex system where one of the control transceivers 419, 421 and 423 are in continual communication with control transceiver 409. In a lesser configuration, one of the transceivers 419, 421 and 423 can trigger action in the control transceiver 409 by sending a first coded signal to indicate stopper member 41 removal, followed by automatic timed shutoff of one of the transceivers 419, 421 and 423, possibly followed by a second coded trigger signal by action in the stopper member 41 to instruct the control transceiver 409 to indicate a non-alarm condition or to stop audible transmission through the speaker 405. One advantage of the system 401 is that the methods discussed indicate that the combination of the housing 403 and stopper member 41 can be utilized with respect to a variety of bottles 21 of different sizes and shapes.

One of the aspects seen with regard to system 401 of FIG. 16 is that as a practical matter the necessity to provide both a stopper member 41 and a base housing 403, and the digital nature of the radio frequency identification enables multiple different sets of stopper members 41 and a base housings 403 to be used in the same case of bottles 21 shipped in a made up fashion. However, the manufacture of sets of stopper members 41 and a base housings 403 would generally fit only with bottles 31 having both a matching base housing 403 and a stopper member 41 of the correct size.

Referring to FIG. 17, a view of a system 451 illustrates a radio frequency identification system 451 with bottle 21, as before, but having an expanded size stopper member 453 with an easy grasp radially expanded portion 455 and including speaker apertures 457. Expanded size stopper member 453 also includes a compressible elastomeric portion 459 and supporting a controlled transceiver 461.

At the bottom of the bottle 21, two examples of a tranceptive/transponsive structure are shown. First, a short length of transmission line 463 is encased in cellophane 465 and adhered to the bottom of the bottle 21. Another transceptive/transponsive structure 467 is shown as a button sized transceptive structure 467 which can be a complete transceiver, but need not be, and is shown adhered to the bottom of the bottle 21, preferably by adhesive or the like. What is immediately noticeable about system 451 is that only the upper expanded size stopper member 453 need be size selected to interfit with the bottle 21. The other structures, including short length of transmission line 463 and transceptive structure 467 are utilizable in the alternative, and need only be placed in a position below the bottle 21 so that it will stand upright. In some cases, the short length of transmission line 463 and transceptive structure 467 may be adhered to the outside of the bottle 21.

The transceiver 461 may have an antenna 469 which may be advantageously oriented to facilitate communications between short length of transmission line 463 and transceptive structure 467. As before, the transceiver 461 can transmit a code over a frequency which matches the reflective characteristics of short length of transmission line 463 and transceptive structure 467. Where the transceiver 461 transmits a code, the code will be reflected and re-received by the control transceiver 461, other structures acting as an electromagnetic mirror. As before, where the control transceiver can perceive a change in condition, the removal of the expanded size stopper member 453 can cause a diminution of signal and indicate an alarm condition through the apertures 457.

Although the reflective transmission line 463 will reflect the same code of signal sent, the transceptive structure 467 can be pre-programmed, even if completely passive to return a differing code. As by example, the control transceiver 461 can send a code, such as “123” and expect to receive a transduced code “456” and may or may not use encryption. The codes can be binary or non-binary. This adds another level of security and variability as a large number of transmitter codes can expect to return an even larger number of received codes. The same energy capturing effects as mentioned above for system 401 can equally apply to transceptive structure 467. The antenna directivity factors can also be used in system 451. System 451 as explained to this point assumes that the physical constructs which indicate removal of the expanded size stopper member 453 are based upon removing the proximity of the expanded size stopper member 453 with respect to the structures 467 and 463. As has also been shown, the expanded size stopper member 453 may also carry structures which indicate removal of the member 453 from the bottle 21.

In a more complex configuration, and referring to both systems 401 and 451, the control transceivers 409, 419, 421 and 423, and 461 can have time sensitive circuitry which can detect the electromagnetic propagation time for signals to travel from the top to the bottom of the bottle 21 or 451. The time of propagation is one measurement, any deviation for which, indicates the shifting of position of the stopper member 452 with respect to the structure 463. Ideally, a frequency will be chosen which will not suffer significant attenuation by the level of liquid within the bottle 21.

In another configuration, and referring to FIG. 17, the expanded size stopper member 453 could be configured to send a strobing signal at the time of activation and where transceptive structure 467 is provided with a code which is accepted by the control transceiver 461 as soon as the transceptive structure 467 is positioned near the expanded size stopper member 453. This technique is used, especially with digital radio frequency identification to automatically match a code with a transceiver without having to adjust dip switches, etc. Where the system 451 is assembled by assembly line, the only action which needs to happen is to place an individual transceptive structure 467 in proximity to the control transceiver 461 long enough for an initial blank condition to be programmed with the code within the transceptive structure 467. Once this occurs, and so long as the power supply, such as a battery 71, connected to the control transceiver 461 isn't interrupted to cause a re-setting of the circuit, the control transceiver 461 will react only to changes in a signal associated with the transceptive structure 467. A time period will typically be programmed to sense the relationship in terms of time of propagation between the structure 467 and the control transceiver 461 to a point of stability temporal stability before the control transceiver 461 will be “armed” to begin detecting and alarming based upon a later occurring removal of the stopper member 453. Once the bottles 21 are capped and once the transceptive structures 467 are added by a conveyor or other process which enables each transceptive structure 467 to be added in a manner as to “program” its associated control transceiver 453, a plurality of systems 451 can be packaged together without interference from each other. The system of FIG. 17 can be easily implemented on any sized bottle 21.

While the present invention has been described in terms of a security mechanism for containers, and more particularly to structures to indicate the breaching of a container, and especially a bottle, the principles contained therein are applicable to other instruments and structures in which opening or tampering is to be accompanied by some form of reaction.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. A system for detecting a breach in containment comprising:
an integral housing for attachment to a bottle having a closure structure;
a light transmitter directed toward one of said bottle and said bottle closure structure and supported by said integral housing;
a light receiver for receiving light from said one of said bottle and said bottle closure structure and supported by said integral housing; and
a circuit connected to said light receiver to detect a change in light returned from said light transmitter and to energize at least one component in response to said change in light returned from said light transmitter.

2. The system for detecting a breach in containment as recited in claim 1 wherein said integral housing has a surface configuration to fit a bottom of said bottle.

3. A system for detecting a breach in containment comprising:
an integral housing for attachment to a bottle having a closure structure;
a displacement detector for attachment to said bottle and for support by said integral housing to detect displacement of a portion of said bottle; and
a circuit connected to said displacement detector to detect a change in position of said light returned from said light transmitter and to energize at least one component in response to said change in position of said portion of said bottle.

4. A system for detecting a breach in containment comprising:
an collar structure for attachment adjacent to a neck of a bottle;
a magnet for insertion int a closure structure;
a switch responsive to a presence of said magnet and supported by said collar structure; and
a circuit connected to said switch to detect presence of said magnet supported by said closure structure and to energize at least one component in response to a change in presence of said magnet.

5. The system for detecting a breach in containment as recited in claim 4 wherein said collar structure comprises a first half housing member and a second half housing member joinable to said first half housing member.

6. The system for detecting a breach in containment as recited in claim 4 wherein said magnet is a threaded structure for facilitating entry into said closure structure.

7. The system for detecting a breach in containment as recited in claim 4 wherein said collar structure comprises a partial collar housing having an internal channel and further comprising a locking tie for securing said partial collar housing to a bottle utilizing said locking tie.

8. A system for detecting a breach in containment comprising:
an integral housing for attachment to a bottle having a closure structure adjacent an opening of said bottle;
continuity detector supported by said integral housing;
a foil structure having a ring for attachment to at least one of said closure structure and said bottle adjacent an opening of said bottle, and electrically connected to said continuity detector, whereby dislodgement of said closure structure will create discontinuity in said foil structure detected by said continuity detector; and
a circuit connected to said continuity detector to energize at least one component in response to said discontinuity detected.

9. The system for detecting a breach in containment as recited in claim 8 wherein said ring of said foil structure contains a central aperture for surrounding said opening of said bottle.

10. A system for detecting a breach in containment comprising:
a bottle having a first end having an opening and a second end;
at least one of an electromagnetic reflective and a transponding structure attached adjacent said second end of said bottle;
a stopper member for interfitting with said opening of said bottle and having a control transceiver for transmitting an electromagnetic signal from said stopper member and for receiving a transmitted electromagnetic signal from said at least one of a reflective and a transponding structure, said control transceiver having circuitry to detect removal of said stopper member from said bottle.

11. The system for detecting a breach in containment as recited in claim 10 wherein said detection of removal of said stopper member from said bottle is performed by measuring the time interval between the time said control transceiver transmits a signal from said stopper member and the time said transmitted signal is received from said at least one of a reflective and a transponding structure as an indication that said stopper member has been removed from said bottle.

12. The system for detecting a breach in containment as recited in claim 10 wherein at least one of said control transceiver and said at least one of a reflective and a transponding structure includes an antenna having a structural orientation and wherein said detection of removal of said stopper member from said bottle is performed by measuring the reception characteristics of said control transceiver in response to a signal from said at least one of a reflective and a transponding structure as an indication that said stopper member has been removed from said bottle.

13. The system for detecting a breach in containment as recited in claim 10 wherein at least one of said transmitted electromagnetic signal and said received electromagnetic signal contains an identification code.
